(19) United States
(12) Patent Application Publication
(10) Pub. No.: US 2023/0358281 A1
(43) Pub. Date: Nov. 9, 2023

(54) TRANSMISSION MECHANISM AND ANTI-BLOCKING MOTOR

(71) Applicant: ZHEJIANG LINIX MOTOR CO., LTD., DONGYANG, ZHEJIANG PROVINCE (CN)

(72) Inventors: SHENGWEI CAO, DONGYANG, ZHEJIANG PROVINCE (CN); SHAN DU, DONGYANG, ZHEJIANG PROVINCE (CN); BINGWEN REN, DONGYANG, ZHEJIANG PROVINCE (CN); ZHUBING LV, DONGYANG, ZHEJIANG PROVINCE (CN); GANGHAO GUO, DONGYANG, ZHEJIANG PROVINCE (CN)

(21) Appl. No.: 18/026,311

(22) PCT Filed: Dec. 21, 2021
(86) PCT No.: PCT/CN2021/139924

§ 371 Date: Mar. 14, 2023

(30) Foreign Application Priority Data
Jun. 30, 2021 (CN) 202110733993.3

(51) Int. Cl. F16D 7/02; H02K 7/14

(52) U.S. Cl. CPC F16D 7/021; H02K 7/145

(57) ABSTRACT

The present invention relates to a transmission mechanism and an anti-blocking motor. The transmission mechanism includes a first moving member for receiving a torque and a second moving member for outputting the torque. The second moving member is sleeved on the circumferential outer side of the first moving member, and forms a linkage cavity. A plurality of linkage blocks are arranged inside the linkage cavity. When the first moving member rotates, the linkage blocks come into contact with the second moving member due to centrifugation, and realize the linkage between the first moving member and the second moving member. The present invention has the advantage of avoiding damage from blockage, and the present invention is simple in structure, convenient to assemble, convenient for subsequent maintenance, not easy to break and long in service life.

### TECHNICAL FIELD OF THE INVENTION

The present invention relates to a transmission mechanism and an anti-blocking motor.

### BACKGROUND OF THE INVENTION

Chinese Invention Patent Application 202021764598.9 disclosed a motor anti-blocking device for a lithium electric drill, comprising a motor, wherein a first rotating shaft is fixed at the output end of the motor; the sidewall of the first rotating shaft is fixedly connected to a plurality of fixation plates arranged in an array, and the other ends of the fixation plates are fixedly connected to connecting plates; the sidewalls of the connecting plates are slidingly connected to support rods through round holes; one ends of the support rods run through the connecting plates and are fixed to connecting blocks, while the other ends thereof are connected to fixation blocks; limiting blocks are arranged on the sidewalls of the round holes; springs are sleeved on the sidewalls of the support rods; the sidewall of a protective cover away from the motor is rotatably connected to a second rotating shaft; one end of the second rotating shaft runs through the protective cover and is fixed to a rotating block; and, a plurality of fixation grooves arranged in an array are formed on the sidewall of the rotating block, and the fixation grooves are matched with the fixation blocks.

When the drill bit is blocked, the second rotating shaft is unable to rotate, while the motor continues to rotate at this time. The rotation of the motor drives the rotation of the first rotating shaft and then drives the rotation of the fixation plates and the connecting plates, so that the first limiting surface slides on the third limiting surface. Meanwhile, the springs are compressed under stress, so that the fixation blocks are detached from the fixation grooves, and the first rotating shaft can continue to rotate to continuously convey the output energy of the motor, thereby avoiding the continuous heating of the motor and avoiding the damage to the motor. However, this scheme is complex in structure, troublesome in the assembly of components, easy to damage and fail, and short in service life.

### SUMMARY OF THE INVENTION

An object of the present invention is to provide a transmission mechanism with simple structure, convenient assembly and long service life.

For this purpose, the present invention employs the following technical solutions. A transmission mechanism is provided, comprising a first moving member for receiving a torque and a second moving member for outputting the torque, wherein the second moving member is sleeved on the circumferential outer side of the first moving member and forms an annular linkage cavity; the distance between the circumferential outer wall and the circumferential inner wall of the linkage cavity is greater than the thickness of the linkage blocks, and a plurality of linkage blocks are arranged inside the linkage cavity;

and, when the first moving member rotates, the linkage blocks come into contact with the second moving member due to centrifugation and realize linkage between the first moving member and the second moving member.

When the first moving member rotates rapidly, the linkage members move in the linkage cavity due to the centrifugal force and move toward the second moving member, so that the linkage members come into contact with the second moving member to finally realize the linkage between the first moving member and the second moving member. When the second moving member is blocked, since there is no any connection and fixation between the second moving member and the linkage blocks, slippage will occur between the second moving member and the linkage blocks, so that the first moving member and the driving mechanism connected to the first moving member are prevented from damage due to blockage. The present invention is simple in structure, convenient to assemble, convenient for subsequent maintenance, not easy to break and long in service life.

Preferably, push members are arranged inside the linkage cavity, the push members are fixed to the linkage blocks, and each linkage block corresponds to at least one push member; and, when the first moving member rotates, the push members are resisted against the linkage blocks. By providing the push members, the effective torque transmission between the first moving member and the linkage blocks is ensured, and the torque output of the second moving member is thus ensured.

Preferentially, the surfaces of the push members used for coming into contact with the linkage blocks are arc surfaces, and the cross sections of the push members are arranged circularly. The outer walls of the push members are of an arc surface structure, so that the contact area between the push members and the linkage members can be reduced.

Preferentially, at least two linkage blocks are arranged inside the linkage cavity; the at least two linkage blocks are arranged annularly at intervals by using the axis of the first moving member as a center; two adjacent linkage blocks do not come into contact with each other; and, at least one push member is arranged between every two adjacent linkage blocks. With the above arrangement, the second moving member is stressed more uniformly, and the torque transmission effect is better.

Preferably, the distance between every two adjacent linkage blocks is greater than the thickness of the push member in the rotation direction of the first moving member. When the at least two linkage blocks are arranged annularly at intervals on the circumferential side of the first moving block and when the first moving member rotates, each push member can only come into contact with one linkage block. One end of the linkage block comes into contact with one push member, while the other end thereof has a gap with another push member, so that the end of the linkage block away from the push member moves due to centrifugation.

Preferably, the outer wall of the first moving member is recessed inward to form limiting grooves, and the linkage blocks partially extend into the limiting grooves. By limiting the displacement of the linkage blocks in the axial direction of the first moving member by the limiting grooves, the axial displacement of the linkage blocks is avoided, and the linkage effect between the linkage blocks and the second moving member is ensured.

Preferably, the linkage blocks include outer sections and inner sections from outside to inside, the inner sections are always located in the limiting grooves, and the width of the outer sections is greater than that of the inner sections. With the above arrangement, the contact area of the linkage blocks with the first moving member and the second moving member is larger, and it is advantageous for torque transmission.

Preferably, the push members are located in the limiting grooves; fixation holes are formed on the first moving member; the fixation holes are communicated with the limiting grooves; the axes of the fixation holes are parallel to the axis of the first moving member; the push members pass through the fixation holes and then extend into the limiting grooves; and, the ends of the push members are fixed in the fixation holes. Since the push members are located in the limiting grooves, the stress points of the linkage blocks are further away from the second moving member, so that the linkage blocks move to the circumferential outer side due to the centrifugal force. By forming the fixation holes, it is convenient to fix thinner push members, so that thinner push members can be used in the present application. Accordingly, it is convenient to reduce the stressed contact area between the linkage blocks and the push members, and it is convenient to replace the push members. The ends of the push members may be fitted in the fixation holes, or may be screwed in the fixation holes.

Preferably, the second moving member is rotatably fixed to a fixation frame, a support groove is formed on the fixation frame, and the second moving member passes through the support groove; a bearing is arranged at the support groove, and the second moving member is fixed to the fixation frame through the bearing; the second moving member comprises a linkage section and a support section in the axial direction; the outer diameter of the linkage section is greater than that of the support section; the linkage section is sleeved on the circumferential outer wall of the first moving member; and, the support section is located on the axial outer side of the first moving member, and the support section is rotatably fixed to the fixation frame. By providing the fixation frame to support the second moving member, the second moving member is prevented from tilting, shaking or even bending and breaking.

The present invention further discloses an anti-blocking motor with the transmission mechanism described above, comprising a motor, an output shaft of the motor being linked with the first moving member. The output shaft of the motor may be linked and fixed to the first moving member in various ways, thereby realizing the anti-blocking function of the motor.

The present invention has the advantage of avoiding damage from blockage, and the present invention is simple in structure, convenient to assemble, convenient for subsequent maintenance, not easy to break and long in service life.

### BRIEF DESCRIPTION OF THE DRAWINGS

FIG. 1 is a schematic structure diagram of a transmission mechanism according to the present invention;

FIG. 2 is a sectional view when the transmission mechanism according to the present invention is linked with an output shaft of a motor;

FIG. 3 is a schematic structure diagram when the first moving member according to the present invention is assembled with linkage blocks;

FIG. 4 is a sectional view of the transmission mechanism according to the present invention;

FIG. 5 is a schematic structure diagram of the first moving member according to the present invention; and

FIG. 6 is a schematic structure diagram of the linkage block according to the present invention.

### DETAILED DESCRIPTION OF THE INVENTION

The present invention will be further described below by specific embodiments with reference to the accompanying drawings.

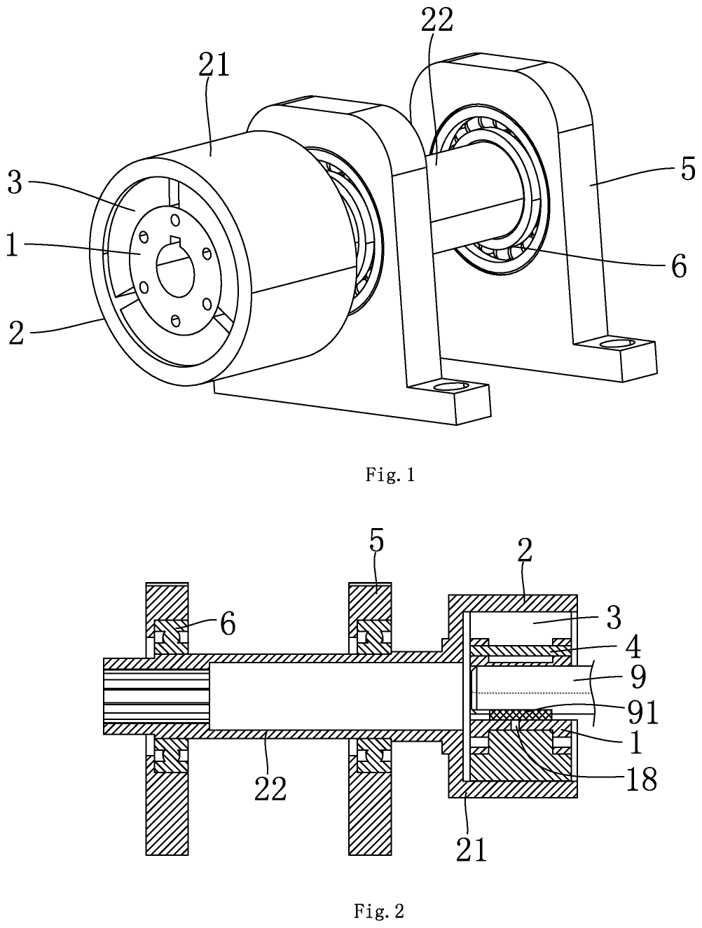

As shown in FIGS. 1 to 6, this embodiment discloses a transmission mechanism, comprising a first moving member 1 for receiving a torque and a second moving member 2 for outputting the torque. The second moving member 2 is sleeved on the circumferential outer side of the first moving member 1 and forms a linkage cavity. Three linkage blocks 3 and three push members 4 are arranged inside the linkage cavity, and the push members 4 are fixed to the first moving member 1. When the first moving member 1 rotates, the push members 4 are resisted against the linkage blocks 3 and push the linkage blocks 3 to rotate about the axis of the first moving member 1. The linkage blocks 3 come into contact with the second moving member 2 due to centrifugation to realize the linkage between the first moving member 1 and the second moving member 2. The cross sections of the linkage blocks 3 are arc-shaped.

As shown in FIG. 4, the distance between the circumferential inner wall and the circumferential outer wall of the linkage cavity is L₂, the thickness of the linkage blocks 3 in the radial direction of the first moving member 1 is L₁, and L₂ is greater than L₁. That is, when the linkage blocks 3 are tightly attached to the first moving member 1, there is a certain gap between the circumferential outer walls of the linkage blocks and the circumferential outer wall of the linkage cavity, so that the ends of the linkage blocks 3 away from the push members 4 are deviated toward the second moving member 2.

As shown in FIGS. 1, 3, 4 and 5, the push members 4 are in one-to-one correspondence to the linkage blocks 3, the surfaces of the push members 4 used for coming into contact with the linkage blocks 3 are arc surfaces, the cross sections of the push members 4 are arranged circularly, and the push members 4 are of a thin cylindrical structure.

The three linkage blocks 3 are arranged annularly at intervals by using the axis of the first moving member 1 as a center. Two adjacent linkage blocks 3 do not come into contact with each other, the distance between two adjacent linkage blocks 3 is greater than the diameter of the push members 4, and one push member 4 is arranged between every two linkage blocks 3.

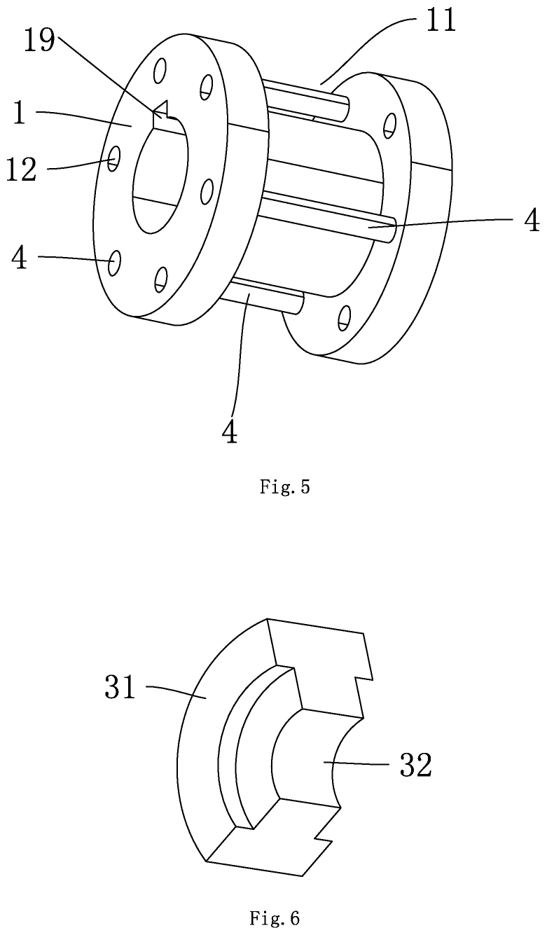

As shown in FIGS. 5 and 6, the outer wall of the first moving member 1 is recessed inward to form limiting grooves 11, and the linkage blocks 3 include outer sections 31 and inner sections from outside to inside. The inner sections 32 are always located in the limiting grooves 11, and the width of the outer sections 21 is greater than that of the inner sections 32 (the width is the distance of the linkage blocks 1 in the axial direction of the first moving member).

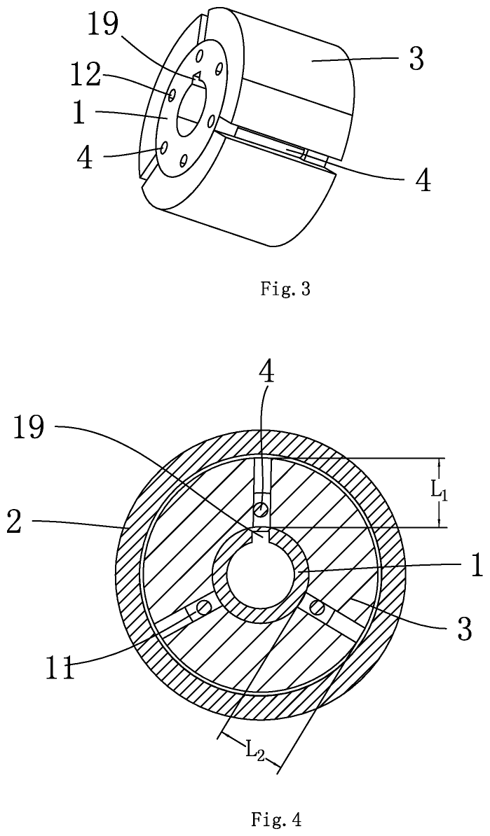

As shown in FIGS. 3 and 5, fixation holes 12 are formed on the first moving member 1, and the fixation holes 12 are communicated with the limiting grooves 11. The axes of the fixation holes 12 are parallel to the axis of the first moving member 1. The push members 4 pass through the fixation holes 12 and then extend into the limiting grooves 11. The ends of the push members 4 are fixed in the fixation holes 12.

As shown in FIGS. 1 to 5, the second moving member 2 is rotatably fixed to a fixation frame 5, a support groove running through the fixation frame is formed on the fixation frame 5. The second moving member 2 passes through the support groove. A bearing 6 is arranged at the support groove, and the second moving member 2 is fixed to the fixation frame 5 through the bearing 6. The second moving member 2 comprises a linkage section 21 and a support section 22 in the axial direction. The outer diameter of the linkage section 21 is greater than that of the support section 22. The linkage section 21 is sleeved on the circumferential outer wall of the first moving member 1, the support section 22 is located on the axial outer side of the first moving member 1, and the support section 22 is rotatably fixed to the fixation frame 5.

As shown in FIG. 2, this embodiment further discloses an anti-blocking motor with the transmission mechanism described above, comprising a motor. An output shaft 9 of the motor is linked with the first moving member 1 through a key 91, and a locking hole 18 running through the first moving member in the radial direction and communicated with a key groove 19 of the first moving member 1 is formed on the first moving member 1. A fastener is fixed in the locking hole to apply a force to the key 91, thereby realizing the fixation of the output shaft 9 and the first moving member 1. The fastener may be a bolt or a jackscrew. By resisting the fastener against the key 91, the axial play of the first moving member 1 relative to the output shaft 9 and the second moving member 2 is avoided, so that the contact of the axial surface of the first moving member 1 with other components is avoided.

The present invention has the advantage of avoiding damage from blockage, and the present invention is simple in structure, convenient to assemble, convenient for subsequent maintenance, not easy to break and long in service life.

1. A transmission mechanism, comprising a first moving member for receiving a torque and a second moving member for outputting the torque, wherein the second moving member is sleeved on a circumferential outer side of the first moving member and forms an annular linkage cavity; the distance between the circumferential outer wall and the circumferential inner wall of the linkage cavity is greater than the thickness of the linkage blocks, and a plurality of linkage blocks are arranged inside the linkage cavity; and, when the first moving member rotates, the linkage blocks come into contact with the second moving member due to centrifugation and realize linkage between the first moving member and the second moving member.

2. The transmission mechanism according to claim 1, wherein push members are arranged inside the linkage cavity, the push members are fixed to the linkage blocks, and each linkage block corresponds to at least one push member; and, when the first moving member rotates, the push members are resisted against the linkage blocks.

3. The transmission mechanism according to claim 2, wherein the surfaces of the push members used for coming into contact with the linkage blocks are arc surfaces, and the cross sections of the push members are arranged circularly.

4. The transmission mechanism according to claim 2, wherein at least two linkage blocks are arranged inside the linkage cavity; the at least two linkage blocks are arranged annularly at intervals by using the axis of the first moving member as a center; two adjacent linkage blocks do not come into contact with each other; and, at least one push member is arranged between every two adjacent linkage blocks.

5. The transmission mechanism according to claim 4, wherein the distance between every two adjacent linkage blocks is greater than the thickness of the push member in the rotation direction of the first moving member.

6. The transmission mechanism according to claim 2, wherein the outer wall of the first moving member is recessed inward to form limiting grooves, and the linkage blocks partially extend into the limiting grooves.

7. The transmission mechanism according to claim 6, wherein the linkage blocks comprise outer sections and inner sections from outside to inside, the inner sections are always located in the limiting grooves, and the width of the outer sections is greater than that of the inner sections.

8. The transmission mechanism according to claim 6, wherein the push members are located in the limiting grooves; fixation holes are formed on the first moving member; the fixation holes are communicated with the limiting grooves; the axes of the fixation holes are parallel to the axis of the first moving member; the push members pass through the fixation holes and then extend into the limiting grooves; and, the ends of the push members are fixed in the fixation holes.

9. The transmission mechanism according to claim 1, wherein the second moving member is rotatably fixed to a fixation frame, a support groove is formed on the fixation frame, and the second moving member passes through the support groove; a bearing is arranged at the support groove, and the second moving member is fixed to the fixation frame through the bearing; the second moving member comprises a linkage section and a support section in the axial direction; the outer diameter of the linkage section is greater than that of the support section; the linkage section is sleeved on the circumferential outer wall of the first moving member; and, the support section is located on the axial outer side of the first moving member, and the support section is rotatably fixed to the fixation frame.

10. An anti-blocking motor having the transmission mechanism according to claim 1, comprising a motor, an output shaft of the motor being linked with the first moving member.

11. The transmission mechanism according to claim 3, wherein at least two linkage blocks are arranged inside the linkage cavity; the at least two linkage blocks are arranged annularly at intervals by using the axis of the first moving member as a center; two adjacent linkage blocks do not come into contact with each other; and, at least one push member is arranged between every two adjacent linkage blocks.

12. The transmission mechanism according to claim 3, wherein the outer wall of the first moving member is recessed inward to form limiting grooves, and the linkage blocks partially extend into the limiting grooves.
